(19) United States
(12) Patent Application Publication
(10) Pub. No.: US 2023/0245128 A1
(43) Pub. Date: Aug. 3, 2023

(54) DETECTING DIGITAL HARVESTING UTILIZING A DYNAMIC TRANSACTION REQUEST FRAUD DETECTION MODEL

(71) Applicant: Chime Financial, Inc., San Francisco, CA (US)

(72) Inventors: Chad Gonzales, Scottsdale, AZ (US); Elizabeth Vogelsang, Oakland, CA (US); Brian Lesperance, River Forest, IL (US); Dain Hall, Chicago, IL (US); David Corson-Knowles, Bellingham, WA (US); Yoanna Todorova, Berkeley, CA (US); Brian Mullins, San Francisco, CA (US)

(21) Appl. No.: 17/590,743

(22) Filed: Feb. 1, 2022

(51) Int. Cl. G06Q 20/40; G06Q 20/38

(52) U.S. Cl. CPC G06Q 20/4016; G06Q 20/405; G06Q 20/382

(57) ABSTRACT

The disclosure describes embodiments of systems, methods, and non-transitory computer readable storage media that utilize a transaction request fraud detection model with a harvesting threshold to detect account number harvesting from network transaction requests. For example, the disclosed systems can identify network transaction requests from a transaction facilitator computing device and transaction request response codes for the network transaction requests. Subsequently, utilizing a transaction request fraud detection model, the disclosed systems can determine that the number of network transaction requests that include declined transaction request response codes satisfies a harvesting threshold indicating an account number harvesting event. In response to the indicated account number harvesting, the disclosed systems can send a selected transaction request response for responses to additional declined network transaction requests instead of one or more original transaction request response codes.

### BACKGROUND

Recent years have seen significant development in systems that utilize web-based and mobile-based applications to manage user accounts and digital information for user accounts in real time. For example, many conventional network-transaction-security systems facilitate payment transactions utilizing credit card information through web-based and/or mobile-based merchant platforms. Oftentimes, such conventional systems face network security threats from malicious parties attempting to identify and steal credit card information through payment transactions on the web-based and/or mobile-based merchant platforms. In particular, a malicious party can construct a script that utilizes potential credit card numbers and other credit card information (e.g., expiration dates, card verification value (CVV) codes, names) with a platform that processes credit-card-transaction authorizations to harvest credit card numbers.

To illustrate, the malicious party obtains the ability to process credit-card-transaction authorizations by compromising the security of a merchant platform to access transaction-authorization-request-response logs, executing a script that enters payment information on the merchant platform, or obtaining the ability to process credit-card-transaction authorizations internally. In many conventional network-transaction-security systems, a credit-card-transaction-authorization request prompts conventional systems to determine if the credit card information is authorized (e.g., as a valid or invalid credit card) and send a transaction request response code that indicates the validity of the credit card information and a description for the acceptance and/or rejection of the credit-card-transaction-authorization request. For example, in many cases, conventional network-transaction-security systems provide transaction request response codes that decline a credit-card-transaction-authorization request with response descriptions, such as mismatched expiration date, incorrect expiration date, incorrect CVV code, insufficient funds, and/or incorrect billing address. Such response descriptions are indicative that a valid credit card has been entered to the malicious party. Indeed, in many cases, the malicious party (via a script) harvests the credit card numbers that are indicated as valid (via the response codes) and utilizes the credit card numbers to perpetuate further fraud (e.g., fraudulent transactions, selling the credit card number).

Although many conventional network-transaction-security systems attempt to detect and safeguard against harvesting attacks, such conventional systems face a number of technical shortcomings, particularly with regard to effectiveness, detection accuracy, and response efficiency. For example, many conventional network-transaction-security systems cannot detect harvesting attacks as the harvesting may occur on the merchant platform level. As a result, conventional systems oftentimes cannot prevent the harvesting of credit card information and/or determine that specific credit card information is compromised until a user reports fraudulent activity. In addition, conventional network-transaction-security systems oftentimes fail to address cyber security issues related to harvesting attacks while flexibly allowing the affected merchant platform to process authorized transactions.

Furthermore, many conventional network-transaction-security systems also cannot accurately detect harvesting attacks. In particular, conventional systems oftentimes, when attempting to identify a harvesting attack, result in a high number of false positive detections due to the high velocity (e.g., frequency) of transactions on many merchant platforms. Indeed, many conventional network-transaction-security systems fail to discern harvesting attacks when a merchant platform may be processing a substantial number of transaction requests (e.g., thousands) in short periods of time.

Additionally, conventional network-transaction-security systems often inefficiently respond to cyber security flaws exploited by harvesting attacks. For instance, many conventional systems (upon failing to detect a harvesting attack) result in theft of credit card numbers. Then, upon detecting fraud perpetuated from the stolen credit card numbers, conventional network-transaction-security systems oftentimes transmit electronic communications to credit card users for the fraudulent activity, generate new credit card numbers for the credit card users, and/or fix (or backtrack) fraudulent transactions from the stolen credit card information. Accordingly, conventional network-transaction-security systems often inefficiently respond to harvesting attacks by causing additional load on servers (or devices) of the credit card issuer, the merchant platforms, and the credit card users when creating new credit cards information, transmitting alerts, and backtracking fraudulent transactions resulting from harvesting attacks.

### SUMMARY

This disclosure describes one or more embodiments of systems, methods, and non-transitory computer readable media that provide benefits and solve one or more of the foregoing or other problems. In particular, the disclosed systems can monitor network transaction requests and use a transaction request fraud detection model to detect account number harvesting from the monitored network transaction requests based on a harvesting threshold. For example, the disclosed systems can identify network transaction requests from a transaction facilitator computing device and transaction request response codes for the network transaction requests. By utilizing a transaction request fraud detection model, the disclosed systems can determine that the number of network transaction requests that include declined transaction request response codes satisfies a harvesting threshold indicating an account number harvesting event. In response to the detected harvesting, the disclosed systems can send a selected transaction request response (e.g., masked response codes) for responses to additional declined network transaction requests instead of one or more original (e.g., would-be default) transaction request response codes that indicate reasons for a network transaction request's declination or acceptance.

### BRIEF DESCRIPTION OF THE DRAWINGS

The detailed description is described with reference to the accompanying drawings in which:

FIG. 1 illustrates a schematic diagram of an environment for implementing an inter-network facilitation system and a data harvesting detection system in accordance with one or more implementations.

FIG. 2 illustrates an overview of a data harvesting detection system detecting an account number harvesting event in accordance with one or more implementations.

FIG. 3 illustrates a data harvesting detection system utilizing a transaction request fraud detection model to detect account number harvesting from network transaction requests in accordance with one or more implementations.

FIG. 4 illustrates a data harvesting detection system sending a selected transaction request response instead of original transaction request response codes in response to detecting account number harvesting in accordance with one or more implementations.

FIG. 5A illustrates a data harvesting detection system transmitting electronic communications to a transaction facilitator device upon detecting account number harvesting in accordance with one or more implementations.

FIG. 5B illustrates a data harvesting detection system configuring notifications for client devices corresponding to account numbers based on an indication of account number harvesting in accordance with one or more implementations.

FIG. 5C illustrates a data harvesting detection system tagging an account number based on an indication of account number harvesting in accordance with one or more implementations.

FIG. 5D illustrates a data harvesting detection system adding a transaction facilitator to a block list based on an account number harvesting indicator in accordance with one or more implementations.

FIG. 6 illustrates a flowchart of a series of acts for utilizing a transaction request fraud detection model with a harvesting threshold to detect account number harvesting from network transaction requests in accordance with one or more implementations.

FIG. 7 illustrates a block diagram of an exemplary computing device in accordance with one or more implementations.

FIG. 8 illustrates an example environment for an inter-network facilitation system in accordance with one or more implementations.

### DETAILED DESCRIPTION

The disclosure describes one or more embodiments of a data harvesting detection system that utilizes a transaction request fraud detection model (e.g., card harvesting detection model) to detect account number harvesting from network transaction requests. For example, the data harvesting detection system can identify (or receive) network transaction requests, for a time period, from a transaction facilitator computing device that processes transaction requests from one or more client devices. In addition, the data harvesting detection system can detect an account number harvesting attack by determining (utilizing a transaction request fraud detection model) that a number of network transaction requests that have declined transaction request response codes satisfies a harvesting threshold. This harvesting threshold indicates account number harvesting has occurred or is in progress. In response to detecting account number harvesting, the data harvesting detection system can send a selected transaction request response (instead of one or more original transaction request response codes) for responses to additional declined network transaction requests. Such selected transaction request responses can remove predictable transaction request response codes that are conventionally sent and thereby deter a detected harvesting attack.

For example, the data harvesting detection system identifies a set of network transaction requests and corresponding transaction request response codes in response to the network transaction requests. In some embodiments, the data harvesting detection system receives the network transaction requests, within a time period, having an account number (e.g., a credit card number) and a transaction amount and determines transaction request response codes for the requests. To illustrate, in some instances, the transaction request response codes include codes for an approved authorization for the network transaction request, incorrect information decline response, a fraud alert decline response, or a user reported decline response.

Subsequently, the data harvesting detection system can utilize a transaction request fraud detection model to analyze the set of network transaction requests to detect account number harvesting. In particular, in some embodiments, the data harvesting detection system determines that, from the time period, a subset of the network transaction requests is associated with declined transaction request response codes. Furthermore, in one or more implementations, the data harvesting detection system determines that the subset of the network transaction requests satisfy a harvesting threshold that indicates the existence of account number harvesting. In some embodiments, the data harvesting detection system utilizes a transaction request fraud detection model that dynamically modifies the harvesting threshold based on transaction data (e.g., transaction types, transaction amounts, transaction velocities) and/or characteristics of a transaction facilitator that corresponds to the network transaction requests.

Upon detecting an indication of account number harvesting, the data harvesting detection system can mask or otherwise modify transaction request response codes for subsequent declined network transaction requests to safeguard against the detected account number harvesting attack. For example, the data harvesting detection system can send (to a recipient computing device of a transaction facilitator) a selected transaction request response for responses to additional declined network transaction requests instead of original transaction request response codes for those additional declined network transaction requests. In some embodiments, by sending the selected transaction request response, the data harvesting detection system conceals the original reason for declining network transaction requests to increase the difficulty of obtaining valid account numbers (e.g., credit card numbers) and/or other information for the account numbers through account number harvesting. In addition, in certain instances, the data harvesting detection system also disables notifications to client devices associated with the account numbers to prevent burdening the communication network and client devices with fraud alerts during an account number harvesting attack.

As suggested above, the data harvesting detection system can provide numerous technical advantages over conventional network-transaction-security systems. For example, the data harvesting detection system improves cyber security by effectively detecting and preventing account number harvesting. Unlike conventional network-transaction-security systems that often cannot detect or prevent harvesting attacks as they occur at a merchant platform level (instead of at the transaction authenticator platform level), the data harvesting detection system can detect and prevent harvesting attacks effectively without having control over the merchant platform level where the harvesting attack occurs.

By detecting harvesting attacks using a harvesting threshold for monitored transaction requests and selectively sending transaction request responses for declined network transaction requests—instead of original transaction request response codes—the data harvesting detection system can prevent a harvesting script from gaining meaningful information for account numbers even when a merchant platform is compromised. Because the selected transaction request responses do not disclose information indicating a reason for declining a requested network transaction present in conventional transaction request response codes, in some embodiments, the data harvesting detection system replaces revealing information from such conventional codes with strategic transaction request responses that stifle data harvesting. Indeed, in some cases, the selected transaction request response masks the declined-reason information revealed by conventional codes. Accordingly, the data harvesting detection system improves security of digital information during network transaction requests.

By detecting harvesting attacks using a harvesting threshold for monitored transaction requests and selectively sending transaction request responses, the data harvesting detection system likewise improves the flexibility of network transaction processing systems. Such a harvesting threshold enables the data harvesting detection system to detect and prevent harvesting attacks without controlling transaction facilitator systems (which process network transaction requests) while also enabling transaction facilitator systems to continue processing approved transaction requests.

Moreover, unlike many conventional network-transaction-security systems that cannot accurately detect harvesting attacks at least at high volumes, the data harvesting detection system can accurately detect harvesting attacks from a large number of and/or high velocity network transaction requests. For example, in contrast to many conventional systems that incur a high number of false positive detections, in some embodiments, the data harvesting detection system can utilize a transaction request fraud detection model that dynamically adjusts the harvesting threshold to account for possible false positive detections from transaction facilitators. By dynamically adjusting the harvesting threshold for a particular transaction facilitator or group of transaction facilitators, the data harvesting detection system can customize a harvesting threshold for the number of network transaction requests and the velocity of the network transaction requests (e.g., the number of network transaction requests in a particular time period) for transaction facilitators. As a result, the data harvesting detection system can accurately detect harvesting when a platform may be processing a substantial number of transaction requests (e.g., thousands) in short periods of time.

In addition to flexible effectiveness and accuracy, in some embodiments, the data harvesting detection system also improves efficiency in security responses to harvesting attacks. As mentioned above, many conventional network-transaction-security systems utilize computing resources to transmit electronic communications to users corresponding to account numbers for the fraudulent activity, generate new account numbers for the users, and/or fix (or backtrack) fraudulent transactions from the stolen account number information upon detecting fraud perpetrated from a harvesting attack. Unlike such conventional systems, in some embodiments, the data harvesting detection system refrains from transmitting electronic communication alerts to client devices upon detecting a harvesting attack to limit communications from computing devices to users of the account numbers—when the detected harvesting attack may not compromise account numbers (e.g., credit card numbers). Because the harvesting threshold facilitates early detection of the harvesting attack and the selected transaction request responses hide or avoid declined-reason information (or, sometimes, approved-transaction information) for declined network transaction requests, the data harvesting detection system can avoid signaling to data-harvesting devices that particular credentials (e.g., credit card numbers or other info) are valid or invalid.

As indicated by the foregoing discussion, the present disclosure utilizes a variety of terms to describe features and advantages of the data harvesting detection system. As used herein, the term “network transaction request” refers to an electronic communication seeking approval or denial of an electronic transaction. In some cases, the network transaction request includes at least one of an account number, a transaction amount, and/or a transaction facilitator identifier as information for a transaction (e.g., an online purchase, an online payment, a deposit, a subscription payment). For example, a network transaction request can include an electronic communication requesting verification of a payment method for an electronic transaction. In certain instances, the network transaction request can include a verification of a payment method (e.g., a credit card, a bank account, a digital wallet).

Furthermore, as used herein, the term “account number” refers to a character-based (e.g., numerical and/or alphabetical) identifier that corresponds to a method of network transactions. For instance, an account number can include an identifier that represents a source of finance, passwords, or other credentials for a transaction. In some embodiments, an account number can include a credit card number, a bank account number, an authentication code for a digital wallet, and/or an authentication password for a digital payment application.

As also user herein, the term “transaction request response code” refers to a label, descriptor, or other text or numeric that describes or indicates a response to a network transaction request. In particular, a transaction request response code includes a label or descriptor for a verification or rejection performed on an account number that corresponds to a network transaction request. To illustrate, a transaction request response code can include a label or descriptor that indicates an approval or denial of a credit card transaction with a reason for the approval or denial. Indeed, a transaction request response code can include codes for an incorrect information decline response, a fraud alert decline response, or a user reported decline response. Additionally, as used herein, the term “original transaction request response code” refers to a code that is an original or default code that has been (or would have been) sent in response to a network transaction request. Such original transaction request response codes include, but are not limited to, N7 for CVV2 failure, 04 for pickup card, 41 for card reported lost, 43 for card reported stolen, or 54 for mismatched expiry or expired card. As indicated above, in some cases, an original transaction request response code is not sent in response to a network transaction request, but the data harvesting detection system instead sends a selected transaction request response (based on a detected harvesting attack) to be used (e.g., by a transaction facilitator) instead of the original transaction request response code.

As further used herein, the term “transaction request fraud detection model” refers to a model that determines (and/or detects) an indication of account number harvesting from network transaction request data. For instance, a transaction request fraud detection model can include a rule-based algorithm or set of functions that analyzes characteristics present in a set of network transaction requests (e.g., a number of transactions, a number of declined transaction request response codes, a velocity of transactions, transaction amounts) to determine signs of account number harvesting. For instance, in one or more embodiments, the transaction request fraud detection model can compare a number of declined transaction request response codes from network transaction requests to a harvesting threshold to indicate account number harvesting. In certain implementations, the transaction request fraud detection model can dynamically adjust (or modify) harvesting thresholds based on characteristics of a transaction facilitator. In some embodiments, the transaction request fraud detection model includes a machine learning model that detects (or classifies) account number harvesting events from input network transaction request data. For instance, in some cases, the transaction request fraud detection model includes a random forest model or a neural network. In certain implementations, the transaction request fraud detection model may be referred to as a card harvesting detection model.

Additionally, as used herein, the term “harvesting threshold” refers to a selected measurement or condition that indicates an account number harvesting event. For example, a harvesting threshold can include a benchmark fraction, number, percentage, or other measurement—or a condition (e.g., a number, Boolean, operational logic)—that, when met, indicates an account number harvesting event. For example, a harvesting threshold can include a benchmark number of declined transaction request response codes that, when achieved, indicates an account number harvesting event.

Indeed, when a harvesting threshold is a selected number (e.g., 10,000; 2 million) of declined transaction request response codes within a particular time period, the data harvesting detection system can determine an indication of account number harvesting upon identifying the selected number (or more) declined transaction request response codes from transaction requests. In one or more embodiments, the harvesting threshold can include various selected numbers of declined transactions (e.g., 5,000; 10,000; 100,000; 2,000,000). Indeed, the data harvesting detection system can utilize any suitable number of declined transactions that satisfy a configurable harvesting threshold within a particular period of time to determine an account number harvesting event.

In some embodiments, a harvesting threshold can be predetermined or configured by an administrator device (e.g., via selection of a particular harvesting threshold). In certain instances, the harvesting threshold is dynamic, and the data harvesting detection system utilizes various characteristics of a transaction facilitator or historical transaction requests to automatically configure the harvesting threshold. As an example, the data harvesting detection system can dynamically increase a harvesting threshold as the number of transaction requests increases within a set of transaction requests received (or processed by) a transaction facilitator. Indeed, in some implementations, a greater number of network transaction requests prompt the data harvesting detection system to increase a harvesting threshold to avoid false positives in higher volume periods of network transaction requests.

As also used herein, the term “transaction facilitator” refers to an entity or a system (e.g., a group of computing devices) that processes, receives, or otherwise facilitates network transactions or network transaction requests. In one or more embodiments, a transaction facilitator includes an entity or a computing system that receives an account number (e.g., credit card number) for a requested transaction and a request to exchange currency, credentials, or other data in exchange for a service, subscription, product, and/or other purpose. For example, a transaction facilitator can include a merchant platform for an e-commerce website, a financial institution for a monetary transfer, and/or a payment recipient.

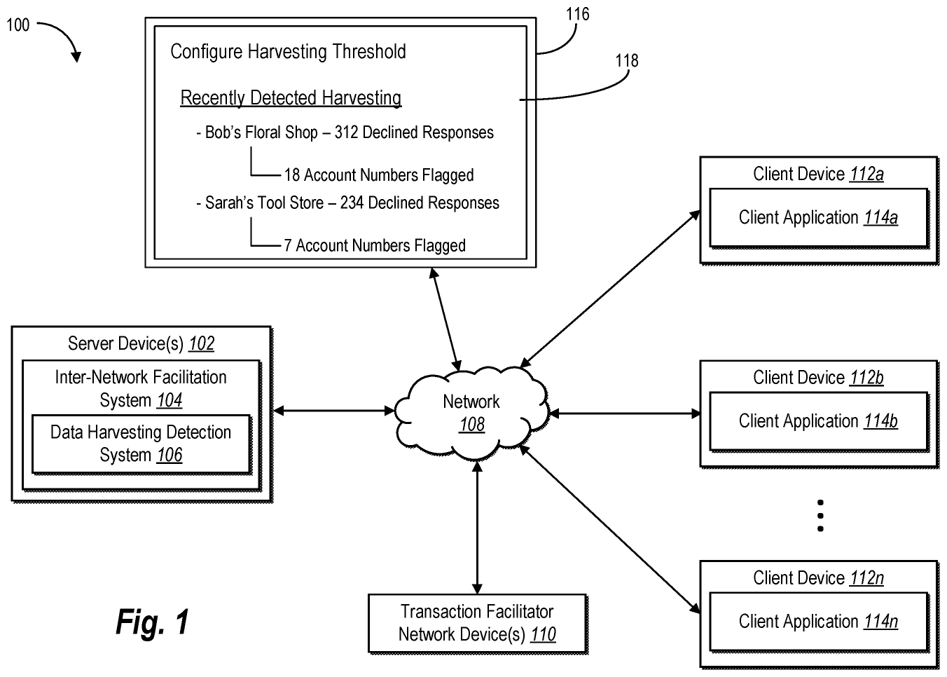

Turning now to the figures, FIG. 1 illustrates a block diagram of a system 100 (or system environment) for implementing an inter-network facilitation system 104 and a data harvesting detection system 106 in accordance with one or more embodiments. As shown in FIG. 1, the system 100 includes server device(s) 102 (which includes the inter-network facilitation system 104 and the data harvesting detection system 106), transaction facilitator network device(s) 110, client devices 112a-112n, and an administrator device 116. As further illustrated in FIG. 1, the server device(s) 102, transaction facilitator network device(s) 110, client devices 112a-112n, and administrator device 116 can communicate via the network 108.

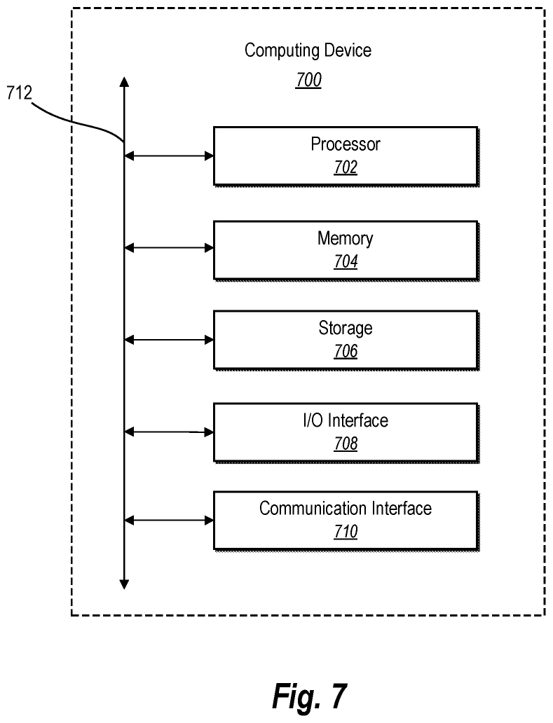

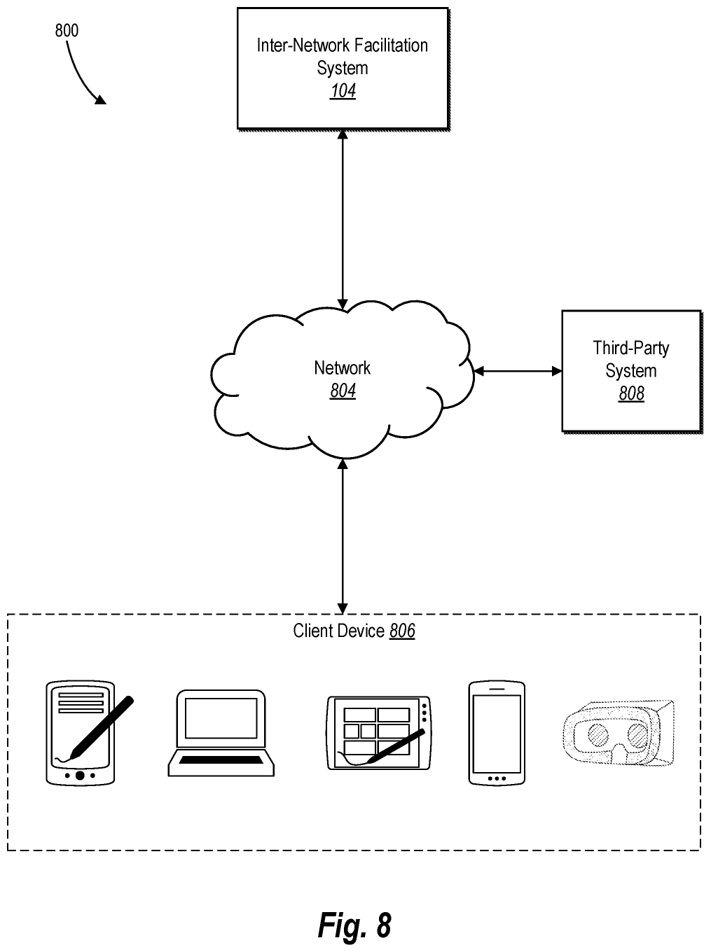

Although FIG. 1 illustrates the data harvesting detection system 106 being implemented by a particular component and/or device within the system 100, the data harvesting detection system 106 can be implemented, in whole or in part, by other computing devices and/or components in the system 100 (e.g., the administrator device 116). Additional description regarding the illustrated computing devices (e.g., the server device(s) 102, the transaction facilitator network device(s) 110, the client devices 112a-112n, the administrator device 116, and/or the network 108) is provided with respect to FIGS. 7 and 8 below.

The inter-network facilitation system 104 can include a system that comprises the data harvesting detection system 106 and that facilitates financial transactions and digital communications across different computing systems over one or more networks. For example, an inter-network facilitation system manages credit accounts, secured accounts, and other accounts for a single account registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

Additionally, the data harvesting detection system 106 can utilize a transaction request fraud detection model with a dynamic harvesting threshold to detect account number harvesting from network transaction requests. Indeed, as mentioned above, the data harvesting detection system 106 can utilize a transaction request fraud detection model to determine that a number of network transaction requests that include declined transaction request response codes satisfies a harvesting threshold indicating an account number harvesting event. Subsequently, the data harvesting detection system 106 can send a selected transaction request response for responses to additional declined network transaction requests instead of one or more original transaction request response codes (in response to the indicated account number harvesting).

As also illustrated in FIG. 1, the system 100 includes the client devices 112a-112n. For example, the client devices 112a-112n may include, but are not limited to, mobile devices (e.g., smartphones, tablets) or other type of computing devices, including those explained below with reference to FIG. 7. Additionally, the client devices 112a-112n can include computing devices associated with (and/or operated by) user accounts for the inter-network facilitation system 104. Moreover, although FIG. 1 illustrates a particular number of client devices (e.g., client devices 112a-112n), the system 100 can include various numbers of client devices that communicate and/or interact with the inter-network facilitation system 104 and/or the data harvesting detection system 106.

Furthermore, as shown in FIG. 1, the client devices 112a-112n include client applications 114a-114n. The client applications 114a-114n can include instructions that (upon execution) cause the client devices 112a-112n to perform various actions. For example, as shown in FIG. 1, a user of a user account can interact with the client applications 114a-114n on the client devices 112a-112n to access financial information, initiate a financial transaction (e.g., utilizing an account number), and/or select (or utilize) a credit value displayed within the client applications 114a-114n.

In certain instances, the client devices 112a-112n correspond to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of an inter-network facilitation system.

In addition, the client applications 114a-114n (via the client devices 112a-112n) can provide user data activity (e.g., network transaction requests) to the data harvesting detection system 106 (via the transaction facilitator network device(s) 110 to the server device(s) 102) to detect account number harvesting. In particular, in one or more embodiments, the client devices 112a-112n can interact with the transaction facilitator network device(s) 110 to perform a network transaction request (e.g., complete an online purchase using a credit card, initiate a subscription). In one or more embodiments, the client applications 114a-114n can include a software implementation for a web browser or mobile application (e.g., an e-commerce mobile application). In some cases, the client device from the client devices 112a-112n can implement a harvesting script to perform an account number harvesting attack towards the transaction facilitator network device(s) 110.

Furthermore, as mentioned above, the system 100 can include the transaction facilitator network device(s) 110. The transaction facilitator network device(s) 110 can receive payment information (e.g., an account number) from a client device of the client devices 112a-112n for a network transaction (e.g., a purchase, a subscription). In addition, the transaction facilitator network device(s) 110 can provide a network transaction request (with an account number) to the inter-network facilitation system 104 for authorization. Indeed, the inter-network facilitation system 104 can receive the network transaction request, determine the validity of the network transaction request, and return a transaction request response code to the transaction facilitator network device(s) 110 indicating whether the network transaction request is approved or denied. In one or more embodiments, the transaction facilitator network device(s) 110 include, but are not limited to, computational devices for merchant platforms for e-commerce websites, a financial institution for monetary transfers, and/or payment recipients.

Additionally, as shown in FIG. 1, the system 100 includes the administrator device 116. For instance, the administrator device 116 may include, but is not limited to, mobile devices (e.g., smartphones, tablets) or other type of computing devices, including those explained below with reference to FIG. 7. As further shown in FIG. 1, the administrator device 116 includes an administrator application 118. Indeed, the administrator application 118 can include instructions that (upon execution) cause the administrator device 116 to perform various actions such as, but not limited to, configuring harvesting thresholds for the transaction request fraud detection model, display alerts (or notifications) corresponding to detected indications of account number harvesting, and/or display tagged account numbers that are determined (by the data harvesting detection system 106) as potentially discovered under a detected account number harvesting event.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 7. Furthermore, although FIG. 1 illustrates the server device(s) 102, the transaction facilitator network device(s) 110, the administrator device 116, and the client devices 112a-112n communicating via the network 108, the various components of the system 100 can communicate and/or interact via other methods (e.g., the server device(s) 102 and the transaction facilitator network device(s) 110 can communicate directly).

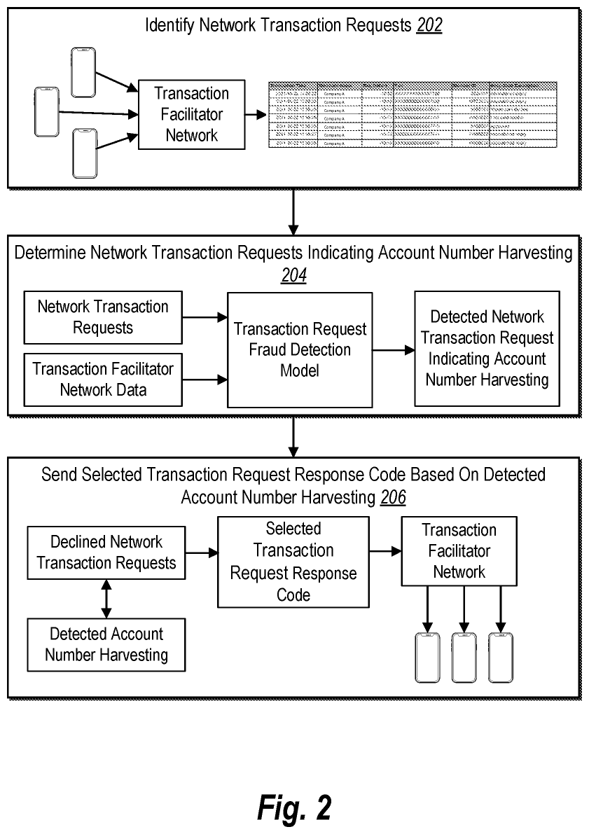

As mentioned above, the data harvesting detection system 106 utilizes a transaction request fraud detection model with a dynamic harvesting threshold to detect account number harvesting from network transaction requests. For example, FIG. 2 illustrates an overview of the data harvesting detection system 106 detecting an account number harvesting event. Additionally, FIG. 2 also illustrates an overview of the data harvesting detection system 106 reacting to the detected account number harvesting event.

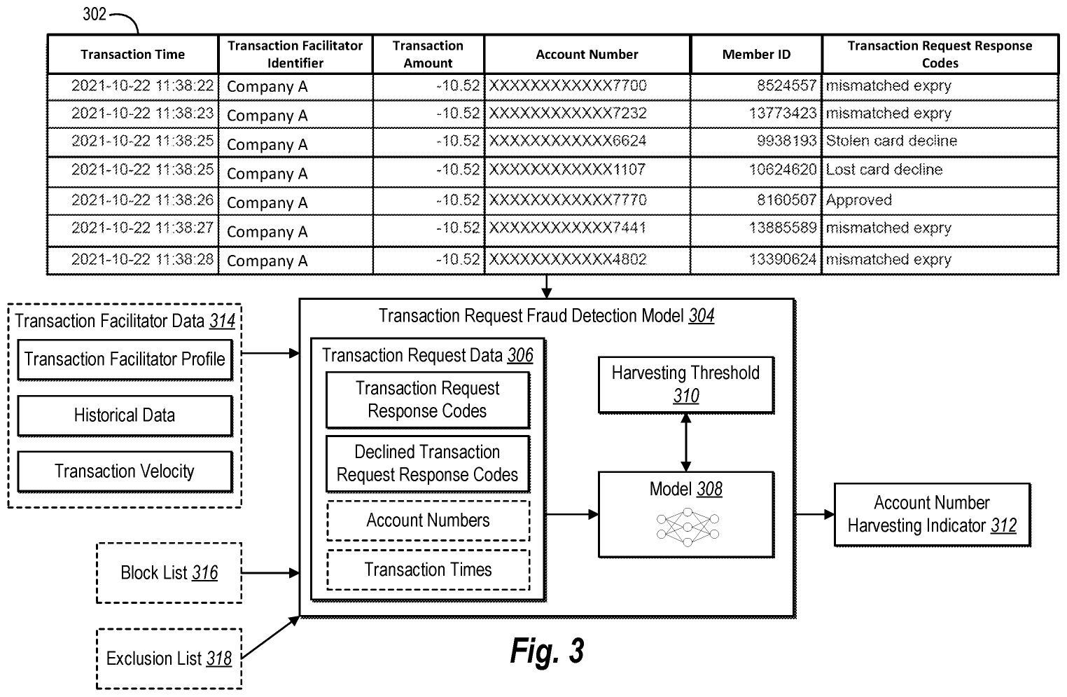

As shown in act 202 of FIG. 2, the data harvesting detection system 106 identifies network transaction requests. In particular, as shown in the act 202 of FIG. 2, a transaction facilitator network receives user interactions from client devices that can include payment interactions (having account numbers). In turn, the transaction facilitator network can generate (or send) a network transaction request to the data harvesting detection system 106 (or the inter-network facilitation system 104). Indeed, the data harvesting detection system 106 can identify the network transaction requests and also determine transaction request response codes (e.g., “resp code description”) for the network transaction requests (as shown in the act 202). Additional detail regarding the data harvesting detection system 106 identifying network transaction requests and corresponding transaction request response codes is described below (e.g., in relation to FIG. 3).

Moreover, as shown in act 204 of FIG. 2, the data harvesting detection system 106 determines network transaction requests indicate account number harvesting. As shown in the act 204 of FIG. 2, the data harvesting detection system 106 can utilize the network transaction requests and data of the transaction facilitator with a transaction request fraud detection model to detect signs of account number harvesting. In certain instances, the data harvesting detection system 106 utilizes the network transaction requests and data of the transaction facilitator to modify and utilize a harvesting threshold to detect signs of account number harvesting within the network transaction requests. Indeed, additional detail regarding the data harvesting detection system 106 determining that network transaction requests indicate account number harvesting is described below (e.g., in relation to FIG. 3).

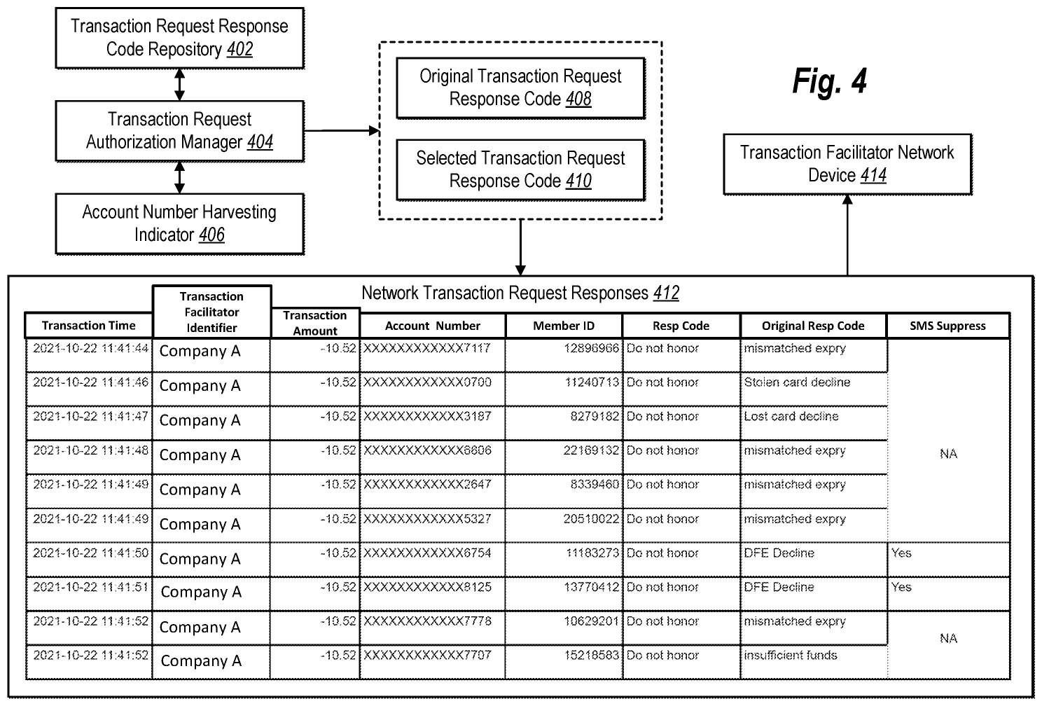

Additionally, as shown in act 206 of FIG. 2, the data harvesting detection system 106 sends a selected transaction request response code (e.g., to a computing device of the transaction facilitator) based on detected account number harvesting. In particular, as shown in the act 206 of FIG. 2, the data harvesting detection system 106 accesses the transaction request response codes when a detected account number harvesting event exists and provides the transaction facilitator with the selected transaction request response code (from the transaction request response codes). Indeed, in one or more embodiments, the selected transaction request response code is not representative of original transaction request response codes for the declined network transaction requests. Additional detail regarding the data harvesting detection system 106 sending selected transaction request response codes instead of original transaction request response codes (in response to detected account number harvesting) is described below (e.g., in relation to FIG. 4).

As mentioned above, the data harvesting detection system 106 can receive network transaction requests from a transaction facilitator network. After receiving and identifying individual network transaction requests, as also mentioned above, the data harvesting detection system 106 can utilize a transaction request fraud detection model to detect account number harvesting from the received network transaction requests. For example, FIG. 3 illustrates the data harvesting detection system 106 receiving network transaction requests and utilizing a transaction request fraud detection model to detect account number harvesting.

To illustrate, as shown in FIG. 3, the data harvesting detection system 106 receives (or identifies) a set of network transaction requests 302 (from a transaction facilitator device). Then, as shown in FIG. 3, the data harvesting detection system 106 utilizes the transaction request fraud detection model 304 with the transaction request data 306 (obtained from the set of network transaction requests 302). For example, as shown in FIG. 3, the transaction request data 306 includes transaction request response codes (e.g., the transaction request response codes or a total count of the transaction request response codes from the set of network transaction requests 302). In addition, as also shown in FIG. 3, the transaction request data 306 includes declined transaction request response codes (e.g., the declined transaction request response codes or a total count of the declined transaction request response codes from the set of network transaction requests 302).

Additionally, as shown in FIG. 3, the data harvesting detection system 106 utilizes a model 308 (of the transaction request fraud detection model 304) to compare the transaction request data 306 to the harvesting threshold 310 to determine signs of account number harvesting for the set of network transaction requests 302. As an example, the data harvesting detection system 106 can compare a number of declined transaction request response codes to the harvesting threshold 310 to determine the account number harvesting indicator 312. For example, when the number of declined transaction request response codes satisfies the harvesting threshold 310, the data harvesting detection system 106 can generate an account number harvesting indicator 312 that indicates the existence of account number harvesting. In some instances, when the number of declined transaction request response codes does not satisfy the harvesting threshold 310, the data harvesting detection system 106 can generate the account number harvesting indicator 312 to indicate no signs of account number harvesting.

As further shown in FIG. 3, the set of network transaction requests 302 include network transaction requests that include transaction times, transaction facilitator identifiers, transaction amounts, account numbers (e.g., PANs), member identifiers, and transaction request response codes. As illustrated in FIG. 3, a transaction time can include a time and date of a network transaction request. In addition, a transaction facilitator identifier can identify the transaction facilitator that received (and is requesting completion of) the network transaction request.

Furthermore, as shown in FIG. 3, a network transaction request includes a transaction amount that indicates a charge amount requested from the account number (e.g., a charge amount to a credit card). In addition, as illustrated in FIG. 3, a network transaction request includes an account number that indicates a monetary source for the network transaction request (e.g., a credit card number, a bank account number). In some cases, the network transaction request can include a complete (unmasked) account number. Additionally, as shown in FIG. 3, a network transaction request includes a member identifier that identifies a user (or user account) that is interacting with the transaction facilitator (and/or with the inter-network facilitation system 104).

As further shown in FIG. 3, the set of network transaction requests 302 include transaction request response codes. Indeed, as shown in FIG. 3, the transaction request response codes indicate whether an account number was approved or declined for a network transaction request (e.g., in some cases determined by the data harvesting detection system 106 or the inter-network facilitation system 104). In addition, the transaction request response codes can also indicate a description or reason for the approval and/or rejection of the account number.

To illustrate, in reference to the set of network transaction requests 302 in FIG. 3, the first network transaction request is declined for having an incorrect expiration date in relation to the account number (e.g., an incorrect expiration date entry for a credit card). In addition, the third network transaction request (from the set of network transaction requests 302) is declined for being reported as a stolen card. Moreover, the fifth network transaction request (from the set of network transaction requests 302) is approved (e.g., approved as a valid credit card). In one or more cases, a harvesting script can utilize the transaction request response codes to determine that the network transaction requests (from the set of network transaction requests 302) are valid account numbers.

In one or more embodiments, the data harvesting detection system 106 (or the inter-network facilitation system 104) can determine and provide various transaction request response codes in response to network transaction requests. In some cases, the data harvesting detection system 106 utilizes transaction request response codes to indicate an approved transaction request (e.g., indicating a valid account number and a successful transaction). In certain instances, the data harvesting detection system 106 utilizes transaction request response codes to indicate a denied transaction request and a reason for the denial.

For example, the data harvesting detection system 106 can utilize transaction request response codes for incorrect information decline responses. To illustrate, a transaction request response code for an incorrect information decline response can include a code (or label) to indicate a response for an incorrect security pin corresponding to an account number (e.g., an incorrect CVV pin for a credit card). In addition, the transaction request response code for an incorrect information decline response can include a code to indicate a response for an incorrect expiration date corresponding to the account number (e.g., an incorrect credit card expiration date). Likewise, the transaction request response codes for incorrect information decline responses can include codes to indicate responses for, but not limited to, an incorrect account number (e.g., an invalid credit card number) and/or an incorrect address corresponding to the account number (e.g., an incorrect billing address for a credit card).

As an example, the data harvesting detection system 106 can utilize transaction request response codes for fraud alert decline responses. For instance, a transaction request response code for a fraud alert decline response can include a code to indicate a response for (detected) fraudulent activity corresponding to the account number. In particular, the data harvesting detection system 106 can determine that the account number is involved in fraudulent activity (e.g., via the account number being flagged, location of transaction, amount of transaction, time of transaction). In some instances, the data harvesting detection system 106 can determine a transaction request response code for a fraud alert decline response that indicates irregular transaction activity for the account number (e.g., increased usage, usage with an irregular transaction facilitator, irregular time or location of transaction).

Furthermore, the data harvesting detection system 106 can utilize transaction request response codes for user reported decline responses. As an example, a transaction request response code for a user reported decline response can include a code to indicate that a user has reported a lost card corresponding to the account number. Moreover, the transaction request response code for a user reported decline response can also include a code to indicate user reported theft of the account number (or a card corresponding to the account number).

Indeed, although various transaction request response codes are described above, the data harvesting detection system 106 can utilize (and/or identify) various types or combinations of transaction request response codes. For example, the transaction request response codes include, but are not limited to, codes to indicate insufficient funds associated with an account number, a closed account associated with the account number, exceeded limits associated with the account number, expired account number, and/or a frozen account associated with the account number. In some cases, the data harvesting detection system 106 also identifies declined transaction request response codes for unissued account numbers from third party account number processing systems.

As further mentioned above, the data harvesting detection system 106 utilizes a transaction request fraud detection model to detect account number harvesting from a set of network transaction requests. Indeed, in one or more embodiments, the data harvesting detection system 106 utilizes the transaction request fraud detection model with a dynamic harvesting threshold to detect account number harvesting events. In particular, the data harvesting detection system 106 can utilize the transaction request fraud detection model to compare various information from a set of network transaction requests to a harvesting threshold to detect account number harvesting events.

As an example, in some embodiments, the data harvesting detection system 106 determines a number of declined transaction request response codes from a set of network transaction requests. Then, the data harvesting detection system 106 compares the number of declined transaction request response codes to the harvesting threshold to detect signs of account number harvesting. For instance, when the number of declined transaction request response codes satisfies the harvesting threshold, the data harvesting detection system 106 indicates that an account number harvesting event is detected within the set of network transaction requests. Although one or more embodiments describe the data harvesting detection system 106 utilizing a number of declined transaction request response codes with a harvesting threshold, the data harvesting detection system 106 can utilize various data from the network transaction requests with the harvesting threshold such as, but not limited to, a number of similar transaction amounts, a number of similar declined transaction request response codes, and/or a number of transaction requests within a time period.

In some cases, the data harvesting detection system 106 utilizes a harvesting threshold that indicates a number of various types of transaction request data. For example, the data harvesting detection system 106 can utilize a harvesting threshold that indicates at least one of, but not limited to, a number of declined transaction request response codes, a number of similar transaction amounts, a number of transaction requests within a time period. Additionally, in one or more embodiments, the data harvesting detection system 106 utilizes a harvesting threshold that indicates a percentage (or ratio).

As an example, in one or more embodiments, the data harvesting detection system 106 utilizes a harvesting threshold that indicates a percentage of declined transaction request response codes in comparison to a total number of transaction request response codes for the set of network transaction requests. Then, the data harvesting detection system 106 can determine a percentage of declined transaction request response codes from a set of network transaction requests and compare the percentage of the declined transaction request response codes to the harvesting threshold. Upon determining that the percentage of the declined transaction request response codes satisfies the harvesting threshold, the data harvesting detection system 106 determines an indication of account number harvesting within a set of network transaction requests.

Furthermore, in one or more embodiments, the data harvesting detection system 106 can utilize various other information to detect account number harvesting from a set of network transaction requests. For example, as shown in FIG. 3, the data harvesting detection system 106 can utilize the transaction request fraud detection model 304 to analyze account numbers from the transaction request data. In particular, in one or more embodiments, the data harvesting detection system 106 can utilize the transaction request fraud detection model to determine that portions of the account numbers (e.g., the first six digits of an account number, the first eight digits of an account number) exhibit a pattern (e.g., a threshold number of account numbers use the same first six digits). Indeed, the data harvesting detection system 106 can utilize the determined pattern in account numbers as an indication of account number harvesting.

In some cases, in reference to FIG. 3, the data harvesting detection system 106 can utilize the transaction request fraud detection model 304 to analyze other information associated with the account numbers from the transaction request data. For example, the data harvesting detection system 106 can utilize the transaction request fraud detection model 304 to analyze, for patterns, data such as, but not limited to, CVV codes associated with network transaction requests, expiration dates associated with the network transaction requests, and/or names associated with the network transaction requests. Indeed, the data harvesting detection system 106 can utilize determined patterns in various information associated with the account numbers during a network transaction request as an indication of account number harvesting.

Furthermore, as shown in FIG. 3, the data harvesting detection system 106 can further utilize transaction times (from the transaction request data 306) with the transaction request fraud detection model to detect an indication of account number harvesting. As an example, in one or more embodiments, the data harvesting detection system 106 utilizes a transaction request velocity to detect account number harvesting. For instance, the data harvesting detection system 106 determines a time between individual network transaction requests (e.g., an average or median time between multiple network transaction requests) as a transaction request velocity. To illustrate, upon determining that a hundred network transaction requests occurred within a time period of one hundred seconds, the data harvesting detection system 106 can determine a transaction request velocity of a network transaction request per second. Indeed, the data harvesting detection system 106 can compare the network transaction request velocity to a harvesting threshold indicating a threshold transaction request velocity to detect an indication of account number harvesting.

As mentioned above, the data harvesting detection system 106 can utilize the transaction request fraud detection model to dynamically determine the harvesting threshold based on data of a transaction facilitator. Indeed, as shown in FIG. 3, the data harvesting detection system 106 can utilize transaction facilitator data 314 (e.g., historical data, transaction velocity, and/or transaction facilitator profile) with the transaction request fraud detection model 304 to determine the harvesting threshold 310. For example, the data harvesting detection system 106 can modify a harvesting threshold to increase and/or decrease the sensitivity of detecting account number harvesting for network transaction requests from particular transaction facilitators. Indeed, the data harvesting detection system 106 utilizes the transaction request fraud detection model to modify the harvesting threshold to reflect activities of a transaction facilitator to reduce false positive detections of account number harvesting from network transaction requests of the transaction facilitator.

As an example, the data harvesting detection system 106 can utilize historical data of a transaction facilitator to determine a harvesting threshold. For example, the data harvesting detection system 106 can identify historical network transaction request data and associated historical account number harvesting detections. Indeed, the data harvesting detection system 106 can utilize information indicating whether the historical account number harvesting detections were accurate and/or false positives to determine a harvesting threshold. For instance, the data harvesting detection system 106 can increase the harvesting threshold proportional to the number of false positive historical account number harvesting detections for the particular transaction facilitator.

Additionally, in some embodiments, the data harvesting detection system 106 can utilize a velocity (or number) of historical network transaction requests from a particular transaction facilitator to modify the harvesting threshold. To illustrate, in one or more embodiments, the data harvesting detection system 106 can increase the harvesting threshold when a transaction facilitator is associated with a greater number of network transaction requests (or a high velocity of network transaction requests). In some instances, the data harvesting detection system 106 can decrease the harvesting threshold when a transaction facilitator is associated with a lesser number of network transaction requests (or a low velocity of network transaction requests). Indeed, in one or more embodiments, the data harvesting detection system 106 can increase and/or decrease the harvesting threshold proportionally to the number of network transaction requests that are associated with the particular transaction facilitator.

In some embodiments, the data harvesting detection system 106 utilizes a transaction facilitator profile to dynamically determine a harvesting threshold. For example, the data harvesting detection system 106 utilizes characteristics of a transaction facilitator from the transaction facilitator profile (e.g., business type, user population, transaction amounts) to determine a harvesting threshold. For instance, the data harvesting detection system 106 can determine different harvesting thresholds for a transaction facilitator that is identified as an e-commerce website versus a transaction facilitator that is identified as a public library. Indeed, the data harvesting detection system 106 can determine a higher harvesting threshold for the transaction facilitator that is an e-commerce website (due to a greater likelihood of receiving numerous network transaction requests) and can determine a lower harvesting threshold for the transaction facilitator that is a public library (e.g., due to a lower likelihood of receiving network transaction requests).

In one or more embodiments, the data harvesting detection system 106 can utilize, with the transaction request fraud detection model, a combination of characteristics from a set of network transaction requests to detect account number harvesting. For example, in some cases, the data harvesting detection system 106 can configure the transaction request fraud detection model to analyze a combination of transaction velocity, transaction amounts, account numbers, and transaction request response codes to detect an indication of account number harvesting. As an example, the data harvesting detection system 106 can utilize the transaction request fraud detection model to indicate account number harvesting when a transaction velocity satisfies a transaction velocity threshold, when a number of transaction amounts are similar (e.g., within an amount range or a threshold number of similar transaction amounts), when a number of account numbers follow a pattern (e.g., a threshold number of account numbers include a similar portion of digits), and/or a number of declined transaction request response codes satisfy a harvesting threshold.

As an example, in some instances, the data harvesting detection system 106 can utilize anomalous changes in declined transaction rates for a transaction facilitator to detect an account number harvesting event. In particular, in one or more embodiments, the data harvesting detection system 106 determines a historical declined transaction rate for a transaction facilitator. Then, the data harvesting detection system 106 can determine a declined transaction rate within a particular time period from a transaction facilitator and compare the declined transaction rate to the historical declined transaction rate to detect an account number harvesting event. Indeed, in some cases, the data harvesting detection system 106 can determine an account number harvesting event if the current declined transaction rate exceeds the historical declined transaction rate for a transaction facilitator by a threshold rate (e.g., as a harvesting threshold).

To illustrate, the data harvesting detection system 106 can determine that a historical declined transaction rate for a transaction facilitator is 5%. Then, the data harvesting detection system 106 can determine that the current declined transaction rate for the transaction facilitator is 20%. Indeed, the data harvesting detection system 106 can utilize the change in declined transaction rate (e.g., 15% change) to identify the transaction facilitator is experiencing an anomalous declined transaction rate (and account number harvesting) when the declined transaction rate satisfies a threshold rate change (e.g., 10% change, 5% change). In some cases, the data harvesting detection system 106 can utilize the anomalous declined transaction rate to further add the transaction facilitator to a block list (as described below).

In some instances, the data harvesting detection system 106 utilizes a block list (e.g., block list 316) with the transaction request fraud detection model (e.g., the transaction request fraud detection model 304). In particular, in one or more embodiments, the data harvesting detection system 106 compares the transaction facilitator identifier to transaction facilitators within the block list. Upon identifying that a transaction facilitator is within the block list, the data harvesting detection system 106 declines network transaction requests from the transaction facilitator (regardless of detecting account number harvesting).

In some cases, the data harvesting detection system 106 further utilizes the transaction request fraud detection model to generate a block list. For example, upon detecting an indication of account number harvesting in relation to a transaction facilitator, the data harvesting detection system 106 can add the transaction facilitator to the block list. In some cases, the data harvesting detection system 106 can determine that account number harvesting is detected for a transaction facilitator for a threshold number of times (e.g., three times, four times, ten times). Upon satisfying the threshold number, the data harvesting detection system 106 can add the transaction facilitator to the block list.

Furthermore, in one or more embodiments, the data harvesting detection system 106 utilizes an exclusion list (e.g., exclusion list 318) with the transaction request fraud detection model (e.g., the transaction request fraud detection model 304). To illustrate, the exclusion list can include a database of transaction facilitators that are excluded from account number harvesting detection. As an example, upon determining that a transaction facilitator identifier belongs to the exclusion list, the data harvesting detection system 106 can ignore an indication of account number harvesting for the transaction facilitator. In some cases, the data harvesting detection system 106 utilizes the exclusion list to prevent detection of false positive account number harvesting events for transaction facilitators that experience a high number of false positive detections.

In some cases, the data harvesting detection system 106 utilizes an exclusion list that is configured by an administrator device (e.g., having transaction facilitators that are added by the administrator device). In some instances, the data harvesting detection system 106 utilizes the transaction request fraud detection model to generate an exclusion list. For instance, the data harvesting detection system 106 can add a transaction facilitator to the exclusion list based on historical data and/or other characteristics of the transaction facilitator. In some cases, the data harvesting detection system 106 can add a transaction facilitator to the exclusion list utilizing historical data, transaction velocity, and/or transaction facilitator profiles as described above.

In some embodiments, the data harvesting detection system 106 can utilize a machine learning-based transaction request fraud detection model. In particular, the data harvesting detection system 106 can utilize machine learning to classify an account number harvesting event from network transaction requests. For instance, the data harvesting detection system 106 can utilize network transaction requests (e.g., for transaction request data) and transaction facilitator characteristics as input to a machine learning model to detect an account number harvesting event. Indeed, the machine learning model can be trained (e.g., using back propagation) to determine that a set of network transaction requests and/or transaction facilitator characteristics indicates signs of an account number harvesting event. Indeed, the data harvesting detection system 106 can utilize various machine learning approaches such as, but not limited to, neural networks, gradient boosting methods, and/or linear regression models to detect account number harvesting from a set of network transaction requests.

Furthermore, the data harvesting detection system 106 can modify (or adjust) the transaction request fraud detection model utilizing harvesting reports from payment facilitator networks (e.g., a credit card institution). For example, the data harvesting detection system 106 can receive, from a payment facilitator, a report that logs (or indicates) reported harvesting events for that payment facilitator. Then, the data harvesting detection system 106 can utilize the reported harvesting events to modify the harvesting threshold (e.g., to increase and/or decrease the sensitivity of the transaction request fraud detection model).

In addition, in certain instances, the data harvesting detection system 106 can utilize the transaction request fraud detection model to detect an account number harvesting event from multiple transaction facilitators. In particular, the data harvesting detection system 106 can determine that multiple transaction facilitators are related (e.g., same parent transaction facilitator, multiple identifiers for a transaction facilitator, partnered transaction facilitators) within the network transaction requests. Then, the data harvesting detection system 106 can utilize the transaction request fraud detection model to detect account number harvesting from network transaction requests that belong to the multiple transaction facilitators (in accordance with one or more embodiments herein).

For example, the data harvesting detection system 106 can utilize a dataset that indicates relationships between transaction facilitator identifiers to determine relationships between transaction facilitators. In some instances, the data harvesting detection system 106 can determine that multiple transaction facilitators are related utilizing processor level data from network transaction requests of the multiple transaction facilitators (e.g., determining that the multiple transaction facilitators utilize common devices or servers). In some cases, the data harvesting detection system 106 can determine that the multiple transaction facilitators are related utilizing network level data (e.g., determining that the multiple transaction facilitators utilize a common IP address and/or network devices).

As further mentioned above, the data harvesting detection system 106 can, in response to detecting an indication of account number harvesting, send a selected transaction request response for responses to additional declined network transaction requests instead of one or more original transaction request response codes. For example, FIG. 4 illustrates the data harvesting detection system 106 sending a selected transaction request response instead of one or more original transaction request response codes in response to detecting account number harvesting. As shown in FIG. 4, the data harvesting detection system 106, via a transaction request authorization manager 404, accesses a transaction request response code repository 402 to select transaction request response codes for network transaction requests of a transaction facilitator.

As further shown in FIG. 4, the data harvesting detection system 106 also listens for (or detects) an account number harvesting indicator 406. Indeed, upon identifying the account number harvesting indicator (determined as described above), the data harvesting detection system 106, via the transaction request authorization manager 404, initiates utilizing a selected transaction request response code 410 instead of the original (original) transaction request response code 408. In some instances, the selected transaction request response code 410 can be specific to the detected account number harvesting as indicated by the account number harvesting indicator 406.

As shown in FIG. 4, the data harvesting detection system 106 utilizes the selected transaction request response code 410 instead of the original (original) transaction request response code 408 in the network transaction request responses 412 for declined network transaction request. As shown in the network transaction request responses 412, the transaction request response code (e.g., “resp code”) includes a selected transaction request response code (e.g., the selected transaction request response code 410). In particular, the data harvesting detection system 106 utilizes a selected transaction request response code that describes the reason for declining the network transaction request to “Do not honor” instead of an original transaction request response code (e.g., “original resp code”). By doing so, the data harvesting detection system 106 masks the actual reason behind a declined transaction request response.

Furthermore, as shown in FIG. 4, the network transaction request responses 412 are provided to the transaction facilitator network device 414. In one or more embodiments, the data harvesting detection system 106 provides the network transaction request responses 412 with the selected transaction request response code. Indeed, in certain instances, the data harvesting detection system 106 omits the original transaction request response codes (e.g., “original resp code”) from the network transaction request responses 412 prior to transmitting the network transaction request responses 412 to the transaction facilitator network device 414.

For example, by omitting the original transaction request response codes and sending the selected transaction request response code for the declined network transaction requests, the data harvesting detection system 106 prevents the effectiveness of a harvesting event. In particular, the data harvesting detection system 106 prevents harvesting scripts from gaining information as to whether an account number was valid or invalid indirectly (e.g., via the response code indicating that the account number was correct, but the expiration date was incorrect).

Although FIG. 4 illustrates the data harvesting detection system 106 utilizing “Do not honor” as the selected transaction request response code, the data harvesting detection system 106 can utilize various transaction request response codes that provide a decline reason without divulging additional information for the account number (e.g., “Declined,” “Error,” “Invalid”). In some cases, the data harvesting detection system 106 can further randomize the selected transaction request response codes instead of providing the original transaction request response code.

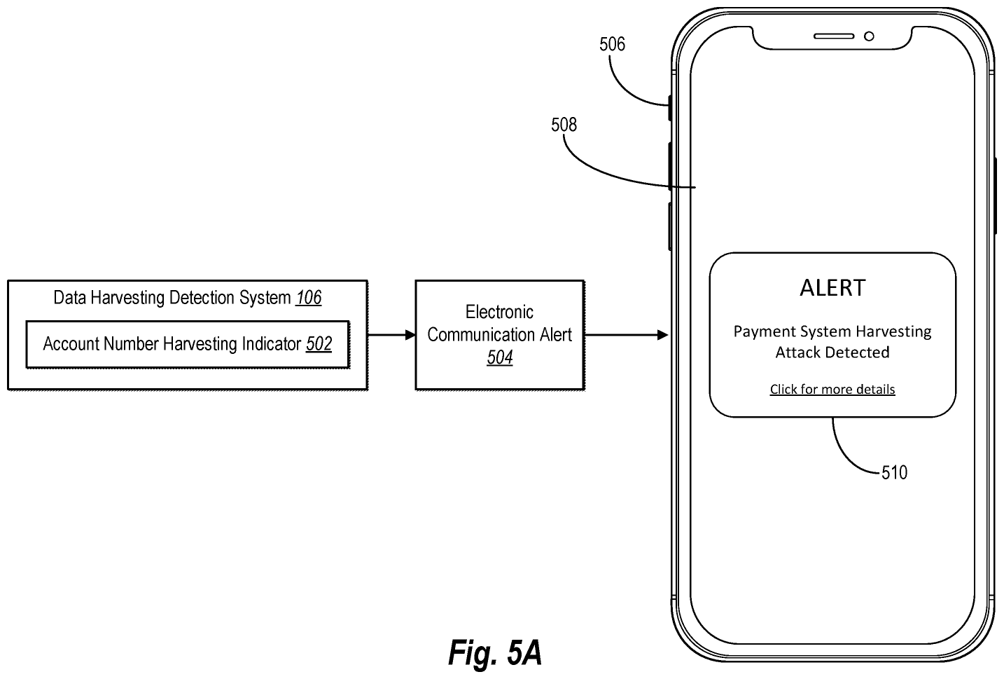

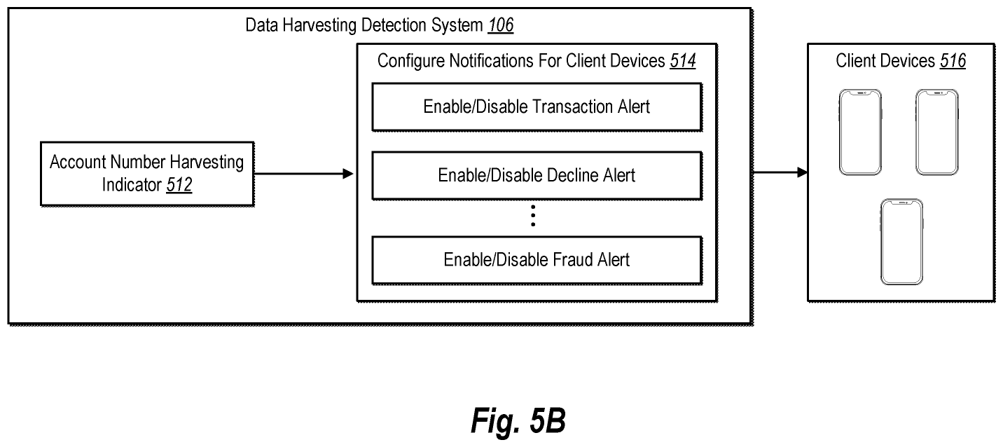

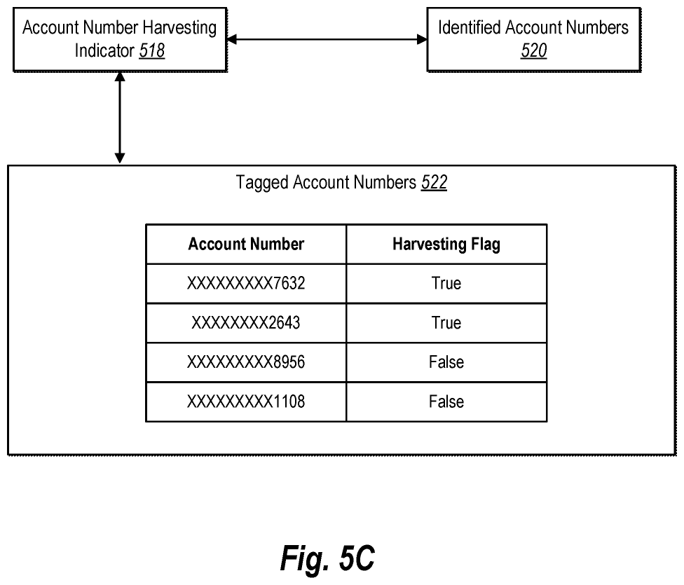

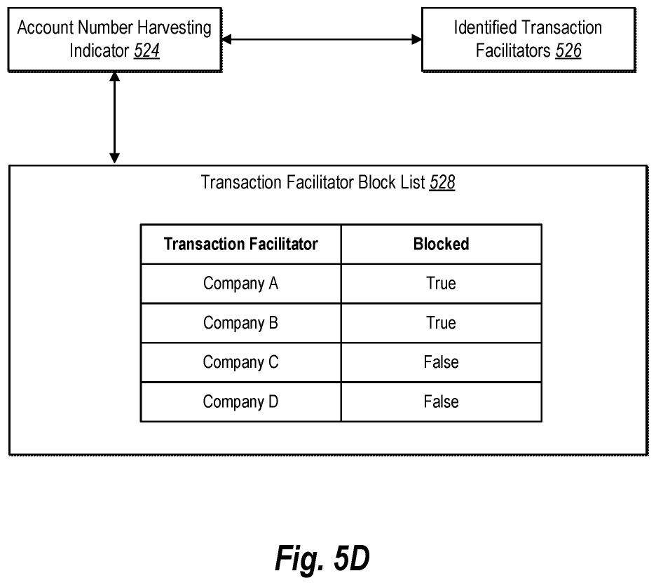

Additionally, the data harvesting detection system 106 can also perform various actions based on detecting account number harvesting from a set of network transaction requests. As an example, in accordance with one or more embodiments, FIG. 5A illustrates the data harvesting detection system 106 transmitting electronic communications to a transaction facilitator device upon detecting account number harvesting from network transaction requests of the transaction facilitator. As shown in FIG. 5A, the data harvesting detection system 106, based on the account number harvesting indicator 502 indicating signs of account number harvesting, transmits an electronic communication alert 504 to the transaction facilitator device 506. Indeed, as illustrated in FIG. 5A, the data harvesting detection system 106 provides the electronic communication alert 504 to the transaction facilitator device 506 to cause the transaction facilitator device 506 to display an alert message 510 within a graphical user interface 508. As further shown in FIG. 5A, the alert message 510 provides information to indicate that an account number harvesting event occurred in relation to network transaction requests associated with the transaction facilitator of the transaction facilitator device 506.

Although FIG. 5A illustrates the data harvesting detection system 106 sending an electronic communication to a transaction facilitator device upon detecting account number harvesting, the data harvesting detection system 106 can send an electronic communication to a variety of participating devices. For example, the data harvesting detection system 106 can send the electronic communication that indicates the detected account number harvesting to a payment facilitator network (e.g., a credit card issuing institution). In some cases, the data harvesting detection system 106 can also send the electronic communication that indicates the detected account number harvesting to the administrator device 116.

As another example, in accordance with one or more embodiments, FIG. 5B illustrates the data harvesting detection system 106 configuring notifications for client devices corresponding to account numbers based on an indication of account number harvesting. As shown in FIG. 5, the data harvesting detection system 106 utilizes an account number harvesting indicator 512 to configure notifications to client devices in an act 514. As shown in FIG. 5B, the data harvesting detection system 106 can configure notifications to client devices by enabling and/or disabling transaction alerts (e.g., alerts that indicate that a transaction has occurred), decline alerts (e.g., alerts that indicate that a transaction using the account number has been declined), and/or fraud alerts (e.g., alerts that indicate that the account number may be involved in fraudulent activity).

Indeed, the data harvesting detection system 106 configures notifications for the client devices 516. The client devices 516 include client devices of users that have an account number with the inter-network facilitation system 104 (e.g., credit card user accounts). In particular, the data harvesting detection system 106 can configure the notifications for client devices based on the account number harvesting indicator to prevent superfluous alerts for the account number when the account number is involved in a harvesting attack, but the account number has not been compromised.

Additionally, as shown in FIG. 5C, the data harvesting detection system 106 can also tag an account number to track the account number for fraud and/or future transaction activity upon detecting an indication of account number harvesting. For example, as shown in FIG. 5C, the data harvesting detection system 106 utilizes identified account numbers 520 from a set of network transaction requests that are associated with an account number harvesting indicator 518 (e.g., the set of network transaction requests indicate signs of account number harvesting). Then, as shown in FIG. 5C, the data harvesting detection system 106 flags the account numbers from the identified account numbers 520 as being involved in a harvesting attack (within a dataset of tagged account numbers 522). For instance, as shown in FIG. 5C, the data harvesting detection system 106 tags the account numbers that are involved in an account number harvesting event with a “true” flag for harvesting. As further shown in FIG. 5C, the data harvesting detection system 106 tags the account numbers that are not involved in an account number harvesting event with a “false” flag.

In some embodiments, the data harvesting detection system 106 tracks transaction activities of flagged account numbers for potentially fraudulent activity. In particular, the data harvesting detection system 106 can track subsequent transactions of the flagged account numbers for inconsistencies (and/or abnormalities) in comparison to earlier transactions with increased sensitivity (e.g., broader fraud detection rules). Likewise, the data harvesting detection system 106 can also modify a risk profile corresponding to a flagged account number. In particular, the data harvesting detection system 106 can modify an indicator that indicates the likelihood of fraudulent activity (e.g., a risk indicator or profile) for the flagged account number.

Moreover, the data harvesting detection system 106 can also add a transaction facilitator to a block list based on an account number harvesting indicator. For example, as shown in FIG. 5D, the data harvesting detection system 106 utilizes identified transaction facilitators 526 that are identified from a set of network transaction requests associated with an account number harvesting indicator 524. Subsequently, as illustrated in FIG. 5D, the data harvesting detection system 106 flags the transaction facilitators from the identified transaction facilitators 526 as being blocked for future transaction requests (e.g., using a Boolean flag) in a transaction facilitator block list 528. Upon being added to the block list, the data harvesting detection system 106 declines future network transaction requests from the blocked transaction facilitator (as described above).

In some cases, the data harvesting detection system 106 adds a transaction facilitator to the transaction facilitator block list 528 based on the detected instance of account number harvesting. In certain instances, the data harvesting detection system 106 determines that a transaction facilitator has been involved (or associated) with a detected harvesting event for a number of times that satisfies a block threshold (e.g., the transaction facilitator has been involved in three detected harvesting events, the transaction facilitator has been involved in four detected harvesting events). In one or more embodiments, the data harvesting detection system 106 can add the transaction facilitator to the block list if the transaction facilitator has been detected to be involved in a threshold frequency of harvesting events (e.g., two per month, two per week).

Although FIGS. 5A-5D illustrate various actions the data harvesting detection system 106 performs in response to an account number harvesting event, the data harvesting detection system 106 can perform various other actions. For example, the data harvesting detection system 106 can, upon detecting account number harvesting, automatically modify account numbers for the account numbers associated with the account number harvesting. In some cases, the data harvesting detection system 106 can, upon detecting account number harvesting, automatically lock (e.g., freeze) account numbers associated with the account number harvesting. In some cases, the data harvesting detection system 106 can rotate (or modify) network identifying portions of an account number (e.g., a bank identification number) for account numbers in response to an account number harvesting event.

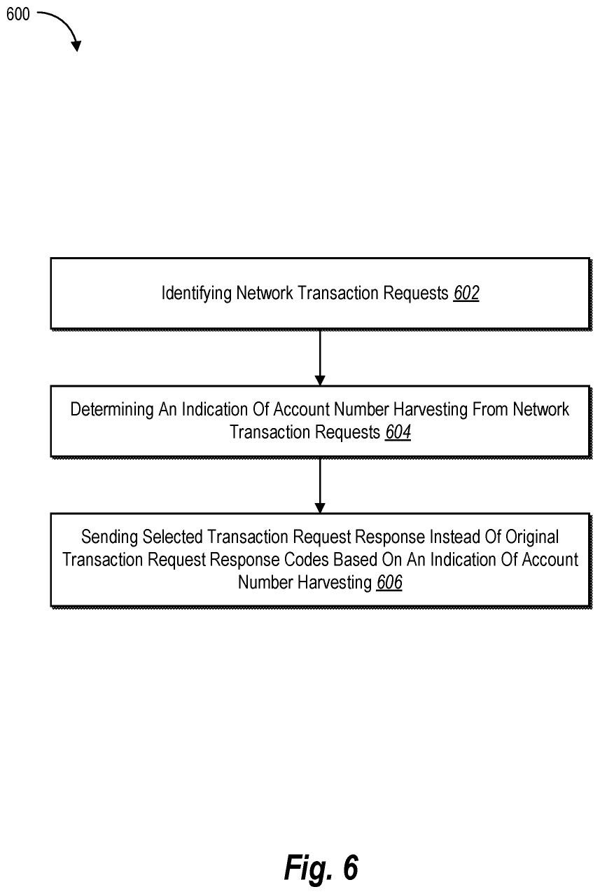

Turning now to FIG. 6, this figure shows a flowchart of a series of acts 600 for utilizing a transaction request fraud detection model with a harvesting threshold to detect account number harvesting from network transaction requests in accordance with one or more implementations. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable storage medium can comprise instructions that, when executed by the one or more processors, cause a computing device to perform the acts depicted in FIG. 6. In still further embodiments, a system can perform the acts of FIG. 6.

As shown in FIG. 6, the series of acts 600 include an act 602 of identifying network transaction requests. In particular, the act 602 can include identifying, for a time period, a set of network transaction requests. For example, a network transaction request can include an account number and a transaction request response code in response to the network transaction request. In one or more embodiments, a transaction request response code includes codes for an incorrect information decline response, a fraud alert decline response, or a user reported decline response.

Furthermore, an incorrect information decline response can include a response indicating an incorrect security pin corresponding to the account number, a response indicating an incorrect expiration date corresponding to the account number, a response indicating the account number as an incorrect account number, or a response indicating an incorrect address corresponding to the account number. Moreover, a fraud alert decline response can include a response indicating fraudulent activity corresponding to the account number or a response indicating an irregular transaction. Additionally, a user reported decline response can include a response indicating a user reported lost card corresponding to the account number or a response indicating a user reported theft of the account number.

As also shown in FIG. 6, the series of acts 600 include an act 604 of determining an indication of account number harvesting from network transaction requests. In particular, the act 604 can include determining, utilizing a transaction request fraud detection model, that a subset of network transaction requests from a set of network transaction requests comprise one or more declined transaction request response codes and satisfy a harvesting threshold indicating an account number harvesting. In certain instances, the act 604 can include utilizing a percentage threshold indicating a percentage of declined network transaction requests as a harvesting threshold. In one or more embodiments, the act 604 includes determining, utilizing a transaction request fraud detection model, a harvesting threshold based on historical data of a transaction facilitator corresponding to a set of network transaction requests.

Furthermore, the act 604 can include identifying, utilizing a transaction request fraud detection model, an indication of account number harvesting by comparing a number of declined transaction request response codes from a subset of network transaction requests to a harvesting threshold. Additionally, the act 604 can include identifying, utilizing a transaction request fraud detection model, matching numbers at designated positions within account numbers as an indication of account number harvesting. Moreover, the act 604 can include determining, utilizing a transaction request fraud detection model, a harvesting threshold based on characteristics of a transaction facilitator corresponding to a set of network transaction requests.

Furthermore, as shown in FIG. 6, the series of acts 600 include an act 606 of sending a selected transaction request response instead of original transaction request response codes based on an indication of account number harvesting. In particular, the act 606 can include, based on a subset of network transaction requests satisfying a harvesting threshold indicating account number harvesting, sending a selected transaction request response for responses to additional declined network transaction requests instead of one or more original transaction request response codes for the additional declined network transaction requests. Additionally, the act 606 can include sending a selected transaction request response code to a recipient computing device of a transaction facilitator to transmit as a response to additional declined digital network transactions requests instead of one or more original transaction request response codes. For example, an original transaction request response code can indicate an original transaction request response to one or more additional declined network transaction requests.

Additionally, the act 606 can include tagging, based on a subset of network transaction requests satisfying a harvesting threshold indicating account number harvesting, account numbers corresponding to the subset of network transaction requests for tracking additional network transaction requests for the account numbers. Moreover, the act 606 can include, based on a subset of network transaction requests satisfying a harvesting threshold indicating account number harvesting, refraining from transmitting electronic communication alerts to client devices corresponding to one or more account numbers from account numbers of a subset of network transaction requests. In addition, the act 606 can include, based on a subset of network transaction requests satisfying a harvesting threshold indicating account number harvesting, transmitting an electronic communication for the indicated account number harvesting to a recipient computing device of a transaction facilitator corresponding to a set of network transaction requests.

Furthermore, the act 606 can include, based on a subset of network transaction requests satisfying a harvesting threshold indicating account number harvesting, blocking a transaction facilitator corresponding to a set of network transaction requests from subsequent network transaction requests. Moreover, the act 606 can include not sending selected transaction request responses instead of original transaction request responses to a transaction facilitator identified within a database of excluded transaction facilitators.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that the data harvesting detection system 106 (or the inter-network facilitation system 104) can comprise implementations of a computing device, including, but not limited to, the devices or systems illustrated in the previous figures. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output (“I/O”) interface 708, which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that couples components of computing device 700 to each other.

FIG. 8 illustrates an example network environment 800 of the inter-network facilitation system 104. The network environment 800 includes a client device 806 (e.g., client devices 112a-112n), an inter-network facilitation system 104, and a third-party system 808 connected to each other by a network 804. Although FIG. 8 illustrates a particular arrangement of the client device 806, the inter-network facilitation system 104, the third-party system 808, and the network 804, this disclosure contemplates any suitable arrangement of client device 806, the inter-network facilitation system 104, the third-party system 808, and the network 804. As an example, and not by way of limitation, two or more of client device 806, the inter-network facilitation system 104, and the third-party system 808 communicate directly, bypassing network 804. As another example, two or more of client device 806, the inter-network facilitation system 104, and the third-party system 808 may be physically or logically co-located with each other in whole or in part.

Moreover, although FIG. 8 illustrates a particular number of client devices 806, inter-network facilitation systems 104, third-party systems 808, and networks 804, this disclosure contemplates any suitable number of client devices 806, inter-network facilitation system 104, third-party systems 808, and networks 804. As an example, and not by way of limitation, network environment 800 may include multiple client devices 806, inter-network facilitation system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, inter-network facilitation system 104 (e.g., which hosts the data harvesting detection system 106), and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 804) to link the third-party-system 808. For example, the inter-network facilitation system 104 may receive authentication credentials from a user to link a third-party system 808 such as an online bank account, credit account, debit account, or other financial account to a user account within the inter-network facilitation system 104. The inter-network facilitation system 104 can subsequently communicate with the third-party system 808 to detect or identify balances, transactions, withdrawal, transfers, deposits, credits, debits, or other transaction types associated with the third-party system 808. The inter-network facilitation system 104 can further provide the aforementioned or other financial information associated with the third-party system 808 for display via the client device 806. In some cases, the inter-network facilitation system 104 links more than one third-party system 808, receiving account information for accounts associated with each respective third-party system 808 and performing operations or transactions between the different systems via authorized network connections.

In particular embodiments, the inter-network facilitation system 104 may interface between an online banking system and a credit processing system via the network 804. For example, the inter-network facilitation system 104 can provide access to a bank account of a third-party system 808 and linked to a user account within the inter-network facilitation system 104. Indeed, the inter-network facilitation system 104 can facilitate access to, and transactions to and from, the bank account of the third-party system 808 via a client application of the inter-network facilitation system 104 on the client device 806. The inter-network facilitation system 104 can also communicate with a credit processing system, an ATM system, and/or other financial systems (e.g., via the network 804) to authorize and process credit charges to a credit account, perform ATM transactions, perform transfers (or other transactions) across accounts of different third-party systems 808, and to present corresponding information via the client device 806.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 808), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 800 either directly or via network 804. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 804.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 806. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 804. A third-party system 808 can communicate with the inter-network facilitation system 104 to provide financial information pertaining to balances, transactions, and other information, whereupon the inter-network facilitation system 104 can provide corresponding information for display via the client device 806. In particular embodiments, a third-party system 808 communicates with the inter-network facilitation system 104 to update account balances, transaction histories, credit usage, and other internal information of the inter-network facilitation system 104 and/or the third-party system 808 based on user interaction with the inter-network facilitation system 104 (e.g., via the client device 806). Indeed, the inter-network facilitation system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying, for a time period, a set of network transaction requests comprising account numbers and transaction request response codes in response to the set of network transaction requests;
determining, utilizing a transaction request fraud detection model, that a subset of network transaction requests from the set of network transaction requests comprise one or more declined transaction request response codes and satisfy a harvesting threshold indicating an account number harvesting; and
based on the subset of network transaction requests satisfying the harvesting threshold indicating the account number harvesting, sending a selected transaction request response for responses to additional declined network transaction requests instead of one or more original transaction request response codes for the additional declined network transaction requests.

2. The computer-implemented method of claim 1, further comprising sending the selected transaction request response code to a recipient computing device of a transaction facilitator to transmit as a response to the additional declined network transactions requests instead of the one or more original transaction request response codes.

3. The computer-implemented method of claim 1, wherein the one or more original transaction request response codes indicate an original transaction request response to the additional declined network transaction requests.

4. The computer-implemented method of claim 1, wherein the transaction request response codes comprise codes for an incorrect information decline response, a fraud alert decline response, or a user reported decline response.

5. The computer-implemented method of claim 4, wherein:
the incorrect information decline response comprises a response indicating an incorrect security pin corresponding to the account number, a response indicating an incorrect expiration date corresponding to the account number, a response indicating the account number as an incorrect account number, or a response indicating an incorrect address corresponding to the account number;
the fraud alert decline response comprises a response indicating fraudulent activity corresponding to the account number or a response indicating an irregular transaction; and
the user reported decline response comprises a response indicating a user reported lost card corresponding to the account number or a response indicating a user reported theft of the account number.

6. The computer-implemented method of claim 1, further comprising utilizing a percentage threshold indicating a percentage of declined network transaction requests as the harvesting threshold.

7. The computer-implemented method of claim 1, further comprising determining, utilizing the transaction request fraud detection model, the harvesting threshold based on historical data of a transaction facilitator corresponding to the set of network transaction requests.

8. The computer-implemented method of claim 1, further comprising identifying, utilizing the transaction request fraud detection model, an indication of the account number harvesting by comparing a number of declined transaction request response codes from the subset of network transaction requests to the harvesting threshold.

9. The computer-implemented method of claim 1, further comprising identifying, utilizing the transaction request fraud detection model, matching numbers at designated positions within the account numbers as an indication of the account number harvesting.

10. The computer-implemented method of claim 1, further comprising tagging, based on the subset of network transaction requests satisfying the harvesting threshold indicating the account number harvesting, one or more account numbers corresponding to the subset of network transaction requests for tracking additional network transaction requests for the one or more account numbers.

11. A non-transitory computer-readable medium storing instructions that, when executed by at least one processor, cause a computing device to:
identify, for a time period, a set of network transaction requests comprising account numbers and transaction request response codes in response to the set of network transaction requests;
determine, utilizing a transaction request fraud detection model, that a subset of network transaction requests from the set of network transaction requests comprise one or more declined transaction request response codes and satisfy a harvesting threshold indicating an account number harvesting; and
based on the subset of network transaction requests satisfying the harvesting threshold indicating the account number harvesting, send a selected transaction request response for responses to additional declined network transaction requests instead of one or more original transaction request response codes for the additional declined network transaction requests.

12. The non-transitory computer-readable medium of claim 11, further comprising instructions that, when executed by the at least one processor, cause the computing device to, based on the subset of network transaction requests satisfying the harvesting threshold indicating the account number harvesting, refrain from transmitting electronic communication alerts to client devices corresponding to one or more account numbers from the account numbers of the subset of network transaction requests.

13. The non-transitory computer-readable medium of claim 11, further comprising instructions that, when executed by the at least one processor, cause the computing device to, based on the subset of network transaction requests satisfying the harvesting threshold indicating the account number harvesting, transmit an electronic communication for the indicated account number harvesting to a recipient computing device of a transaction facilitator corresponding to the set of network transaction requests.

14. The non-transitory computer-readable medium of claim 11, further comprising instructions that, when executed by the at least one processor, cause the computing device to, based on the subset of network transaction requests satisfying the harvesting threshold indicating the account number harvesting, block a transaction facilitator corresponding to the set of network transaction requests from subsequent network transaction requests.

15. The non-transitory computer-readable medium of claim 11, further comprising instructions that, when executed by the at least one processor, cause the computing device to not send selected transaction request responses instead of original transaction request responses to a transaction facilitator identified within a database of excluded transaction facilitators.

16. A system comprising:
at least one processor; and
at least one non-transitory computer-readable storage medium storing instructions that, when executed by the at least one processor, cause the system to:
identify, for a time period, a set of network transaction requests comprising account numbers and transaction request response codes in response to the set of network transaction requests;
determine, utilizing a transaction request fraud detection model, that a subset of network transaction requests from the set of network transaction requests comprise one or more declined transaction request response codes and satisfy a harvesting threshold indicating an account number harvesting; and
based on the subset of network transaction requests satisfying the harvesting threshold indicating the account number harvesting, send a selected transaction request response for responses to additional declined network transaction requests instead of one or more original transaction request response codes for the additional declined network transaction requests.

17. The system of claim 16, further comprising instructions that, when executed by the at least one processor, cause the system to send the selected transaction request response code to a recipient computing device of a transaction facilitator to transmit as a response to the additional declined digital network transactions requests instead of the one or more original transaction request response codes.

18. The system of claim 16, further comprising instructions that, when executed by the at least one processor, cause the system to identify, utilizing the transaction request fraud detection model, an indication of the account number harvesting by comparing a number of declined transaction request response codes from the subset of network transaction requests to the harvesting threshold.

19. The system of claim 16, further comprising instructions that, when executed by the at least one processor, cause the system to utilize a percentage threshold indicating a percentage of declined network transaction requests as the harvesting threshold.

20. The system of claim 16, further comprising instructions that, when executed by the at least one processor, cause the system to determine, utilizing the transaction request fraud detection model, the harvesting threshold based on characteristics of a transaction facilitator corresponding to the set of network transaction requests.
